(19) United States
(12) Patent Application Publication
(10) Pub. No.: US 2015/0352825 A1
(43) Pub. Date: Dec. 10, 2015

(54) METHOD FOR PRODUCING A METAL SHEET HAVING ZN-AL-MG COATINGS COMPRISING THE APPLICATION OF AN ACID SOLUTION AND AN ADHESIVE, AND CORRESPONSING METAL SHEET AND ASSEMBLY

(71) Applicant: ARCELORMITTAL INVESTIGACIÓN Y DESARROLLO, S.L., Sestao, Bizkaia (ES)

(72) Inventors: Joëlle RICHARD, Chantilly (FR); Eric JACQUESON, Longeville Les Metz (FR); Audrey LHERMEROULT, Metz (FR); Pascale FELTIN, Saint Privat La Montagne (FR); Jean-Michel LEMAIRE, Villers Saint Paul (FR)

(21) Appl. No.: 14/397,112

(22) PCT Filed: Apr. 25, 2013
(86) PCT No.: PCT/IB2013/053280

§ 371 Date: Jul. 18, 2015

(30) Foreign Application Priority Data
Apr. 25, 2012 (FR) PCTFR2012050913

(51) Int. Cl. B32B 37/24; B32B 15/01; B32B 37/12; C23C 2/06; C23C 2/26

(52) U.S. Cl. CPC B32B 37/24; C23C 2/06; C23C 2/26; B32B 37/1284; B32B 15/012; B32B 2605/08

(57) ABSTRACT

A method for producing a metal sheet is provided. The method includes providing a steel substrate having two faces coated by dipping the substrate in a bath, applying an acid solution with a pH comprised between 1 and 4 on the outer surfaces of the metal coatings and applying an adhesive locally on at least one outer surface of a metal coating.

The present invention relates to a metal sheet comprising a steel substrate having two faces each coated with a metal coating comprising zinc, magnesium and aluminum.

### BACKGROUND

Such metal sheets are more particularly intended to manufacture parts for the automobile industry, but are not limited thereto.

The metal coatings, essentially comprising zinc and aluminum in small proportions (typically approximately 0.1 wt %), are traditionally used for good corrosion protection. These metal coatings are currently subject to competition in particular from coatings comprising zinc, magnesium and aluminum.

Such metal coatings will be globally referred to hereinafter as zinc-aluminum-magnesium or ZnAlMg coatings.

Adding magnesium significantly increases the resistance of these coatings to corrosion, which may make it possible to reduce their thickness or increase the corrosion protection guarantee over time.

In the automobile industry in particular, the metal sheets are frequently assembled using adhesives to produce certain parts of the vehicles, such as door thresholds, for example.

These adhesives can be structural, reinforced structural (for example, of the “crash” type) or semi-structural adhesives, sealing putties or wedging putties of various chemical natures, such as epoxy, polyurethane or rubber.

In the automobile industry, the association of a metal sheet with an adhesive is typically evaluated using a traction test on a test piece formed by two tongues of the metal sheet, those tongues being glued on part of their surface by the adhesive.

On that occasion, the adherence of the adhesive on the metal sheet is evaluated by measuring the tensile stress at break on the one hand, and the compatibility of the adhesive and the metal sheet by visually determining the nature of the break on the other hand.

On this occasion, it is possible in particular to observe three break types, or facies:
cohesive break, when the break occurs in the thickness of the adhesive,
adhesive break (FIG. 4), when the break takes place at one of the interfaces between the tongues and the adhesive,
surface cohesive break (FIG. 3), when the break takes place in the adhesive near one of the interfaces between the tongues and the adhesive.

In the automobile industry, efforts are made to avoid adhesive breaks, which result in poor compatibility of the adhesive with the metal sheet.

However, traction tests show a large majority of adhesive breaks during the use of certain adhesives that are standard for the automobile industry on metal sheets with ZnAlMg coatings. It is thus possible to observe up to 100% adhesive break with ZnAlMg coatings and certain adhesives.

Such adhesive break proportions are not acceptable for automobile guilders, which could limit the use of those new ZnAlMg coatings for certain applications.

### SUMMARY OF THE INVENTION

An object of the present invention is therefore to provide a method for producing a metal sheet with ZnAlMg coatings that has better compatibility with the adhesives and therefore limits the risks of adhesive break.

The present invention first provides a method for producing a metal sheet, the method comprising at least the following steps of providing a steel substrate having two faces each coated with a metal coating obtained by dipping the substrate in a bath and cooling, each metal coating comprising zinc, between 0.7 and 6 wt % of aluminum, and between 0.1 and 10 wt % of magnesium, then applying an acid solution with a pH comprised between 1 and 4 on the outer surfaces of the metal coatings, then applying an adhesive chosen from among structural, reinforced structural or semi-structural adhesives, sealing putties and wedging putties locally on at least one outer surface of a metal coating, then assembling with a second metal sheet via the adhesive.

The present invention also provides a metal sheet.

### BRIEF DESCRIPTION OF THE DRAWINGS

The present invention will now be illustrated through examples provided for information, and non-limitingly, in reference to the appended figures, in which:

FIG. 1 is a diagrammatic cross-sectional view illustrating the structure of a metal sheet obtained using a method according to the present invention,

FIG. 2 is a diagrammatic view showing a test piece used for a traction test; and

FIGS. 3 and 4 are negatives respectively showing a surface cohesive break and an adhesive break.

### DETAILED DESCRIPTION

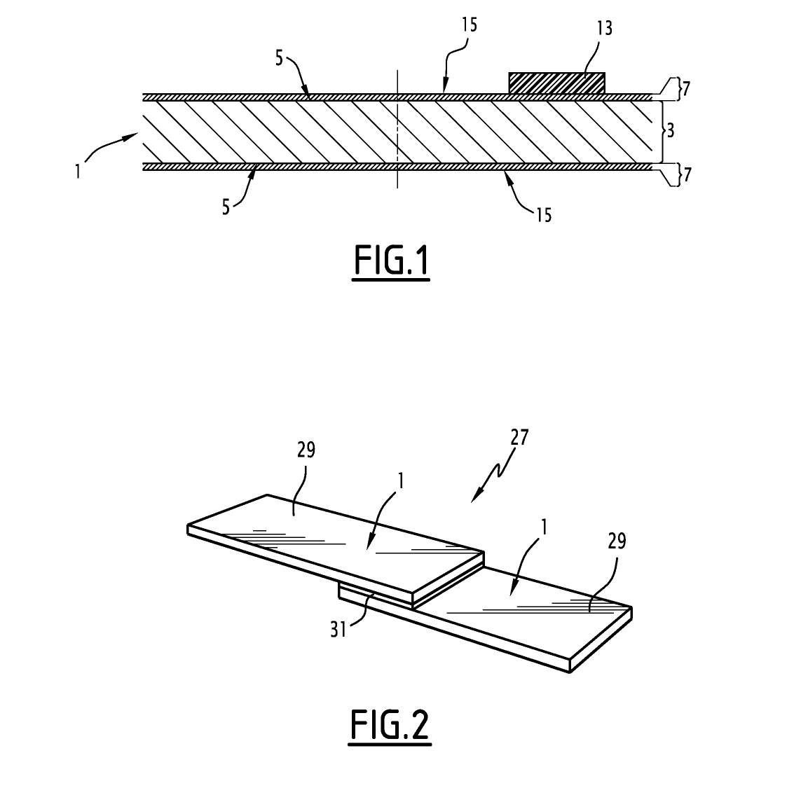

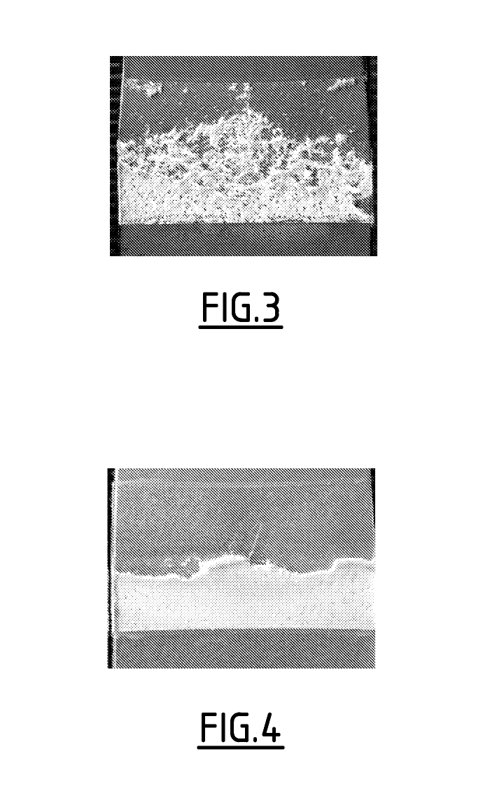

The metal sheet 1 of FIG. 1 comprises a steel substrate 3 covered on each of its two faces 5 by a metal coating 7.

It will be noted that the relative thicknesses of the substrate 3 and of the coatings 7 covering are not shown to scale in FIG. 1 in order to facilitate the illustration.

The coatings 7 present on the two faces 5 are similar, and only one will be described in detail below.

The coating 7 generally has a thickness smaller than or equal to 25 μm, for example, and traditionally aims to protect the substrate 3 from corrosion.

The coating 7 comprises zinc, aluminum and magnesium. It is in particular preferred for the coating 7 to comprise, for example, between 0.1 and 10 wt % of magnesium and between 0.1 and 20 wt % of aluminum.

Also preferably, the coating 7 comprises more than 0.3 wt % of magnesium, or even between 0.3 wt % and 4 wt % of magnesium and/or between 0.5 and 11 wt % or even between 0.7 and 6 wt % of aluminum, or even between 1 and 6 wt % of aluminum.

Preferably, the Mg/Al weight ratio between the magnesium and the aluminum in the coating 7 is less than or equal to 1, or even strictly less than 1, or even strictly less than 0.9.

To produce the metal sheet 1, the following method may for example be used.

A substrate 3 is used that is for example obtained by hot, then cold rolling. The substrate 3 is in the form of a band that is caused to pass through a bath to deposit the coatings 7 by hot dipping.

The bath is a molten zinc bath containing magnesium and aluminum. The bath may also contain up to 0.3 wt % of each of the optional additional elements, such as Si, Sb, Pb, Ti, Ca, Mn, Sn, La, Ce, Cr, Ni, Zr or Bi.

These different elements may make it possible, inter alia, to improve the ductility or adhesion of the coatings 7 on the substrate 3. One skilled in the art who knows their effects on the characteristics of the coatings 7 will know how to use them based on the complementary aim sought. The bath may lastly contain residual elements coming from supply ingots or resulting from the passage of the substrate 3 in the bath, such as iron with a content of up to 5 wt %, and generally comprised between 2 and 4 wt %, for example.

After depositing the coatings 7, the substrate 3 is for example spun dry using nozzles projecting a gas on either side of the substrate 3. The coatings 7 are then left to cool in a controlled manner.

The band thus treated may next undergo a so-called skin-pass step, which makes it possible to cold work it so as to erase the elasticity plateau, set the mechanical characteristics and give it a roughness suitable for the subsequent operations that the metal sheet must undergo.

The means for adjusting the skin-pass operation is the elongation level, which must be sufficient to achieve the aims and small enough to preserve the subsequent deformation capacity. The elongation level is typically comprised between 0.3 and 3 wt %, and preferably between 0.3 and 2.2%.

The metal sheet 1 thus obtained can be wound before being cut, optionally shaped and assembled with other metal sheets 1 or other elements by users.

It may traditionally be oiled for temporary protection purposes.

As diagrammatically illustrated in FIG. 1, an adhesive 13 can be applied locally on an outer surface 15 of a coating 7 so as for example to make it possible to assemble the metal sheet 1 to another metal sheet and thus form part of the automobile vehicle. The adhesive 13 can be of any glue or putty type traditionally used in the automobile industry.

According to the present invention, the method for producing the metal sheet 1 comprises a step for applying an acid solution on the outer surfaces 15 of the metal coatings 7, before any subsequent application of an adhesive 13.

The acid solution for example has a pH comprised between 1 and 4, preferably between 1 and 3.5, preferably between 1 and 3, and still more preferably between 1 and 2. The solution may for example comprise hydrochloric acid, sulfuric acid or phosphoric acid.

The application duration of the acid solution may be comprised between 0.2 s and 30 s, preferably between 0.2 s and 15 s, and still more preferably between 0.5 s and 15 s, as a function of the pH of the solution, and the moment and manner in which it is applied.

This solution may for example be applied on the production line for the coatings 7 or subsequently, for example, after the metal sheet has been wound upon leaving the line for depositing the coatings 7.

The solution may be applied by immersion, aspersion or any other system. The temperature of the solution may for example be the ambient temperature any subsequent rinsing and drying steps can be used.

It is also possible to use, in addition to the step for applying an acid solution, a degreasing step, for example by applying an alkaline solution on the outer surfaces 15 and/or a surface treatment step.

The purpose of the degreasing step is to clean the outer surfaces 15 and therefore remove the traces of organic dirtying, metal particles and dust.

Preferably, this step does not alter the chemical nature of the outer surfaces 15, with the exception of altering any aluminum oxide/hydroxide surface layer. Thus, the solution used for this degreasing step is non-oxidizing. As a result, no magnesium oxide or magnesium hydroxide is formed on the outer surfaces 15 during the degreasing step, and more generally before the adhesive 13 application step.

The surface treatment step comprises applying, on the outer surfaces 15, layers improving the corrosion resistance and/or the adherence of other layers subsequently deposited on the outer surfaces 15. Such a surface treatment step comprises applying, on the outer surfaces 15, a surface treatment solution that reacts chemically with the outer surfaces 15 to form said layers.

In certain alternatives, the surface treatment solution is a conversion solution and the layers formed are conversion layers. Preferably, the conversion solution does not contain chromium. It may thus be a hexafluorotitanic or hexafluorozirconic acid-based solution, for example.

Any degreasing and surface treatment steps can traditionally comprise other traditional rinsing, drying, etc. sub-steps.

Any degreasing step takes place before or after the step for applying the acid solution. Any degreasing step and the step for applying the acid solution take place before or after any surface treatment step.

In one alternative, the step for applying the acid solution and the surface treatment step are combined.

In the latter case, the surface treatment solution used is acid. In that case in particular, the pH can be strictly greater than 3, in particular if the surface treatment solution is applied at a temperature above 30° C.

In order to illustrate the invention, traction tests were performed and will be described as non-limiting examples.

As illustrated by FIG. 2, each test piece 27 is prepared as follows. The tongues 29 are cut out in the metal sheet 1 to be evaluated. These tongues 29 have dimensions of, for example, 25 mm by 100 mm. The tongues 29 are glued by a seal 31 of adhesive BM1496V, which is an epoxy-based so-called “crash” glue marketed by the company Dow Automotive.

This adhesive has been selected because it is one of the adhesives leading to the largest number of adhesive breaks.

The test piece 27 thus formed is next brought to 180° C. and kept at that temperature for 30 minutes.

The traction test is next carried out at an ambient temperature of 23° C. by imposing a traction test of 10 mm/min on a tongue 29, parallel thereto, while the other tongue 29 is fixed. The test is continued until the test piece 27 breaks.

At the end of the test, the maximum tensile stress is noted and the nature of the break is evaluated visually.

The tests were carried out with a metal sheet 1 whereof the substrate is an IFHR 340 steel 1 mm thick covered with coatings 7 comprising 3.7% aluminum and 3% magnesium, the rest being made up of zinc and impurities inherent to the method. These coatings have thicknesses of approximately 10 μm. The metal sheet 1 has also been oiled beforehand with a Quaker 6130 oil and a spread of 1 g/m².

As illustrated by table 1 below, the metal sheets 1 that have undergone a treatment with an acid solution favor the appearance of surface cohesive breaks contrary to the reference metal sheets for which only adhesive breaks are observed.

In the conducted tests, the reference sheets have not undergone any treatment.

TABLE 1

| | Reference | Test 1 | Test 2 | Test 3 |
|---|---|---|---|---|
| Applied | | HCl | HCl | HCl |
| treatment: | | t = 15 s | t = 30 s | t = 30 s |
| nature of the | | pH = 1 | pH = 1 | pH = 2 |
| acid, | | | | |
| application | | | | |
| duration, pH | | | | |
| of the solution | | | | |
| Tensile stress at | 19.3 ± 0.4 | 22.0 ± 0.39 | 21.1 ± 0.1 | 20.9 ± 0.5 |
| break (in Mpa) | | | | |
| Types of | 100% AB | 45% SCB | 35% SCB | 25% SCB |
| break | | 55% AB | 65% AB | 75% AB |

Similar results were obtained after aging the test pieces in a corrosive environments, with other acids, other coatings 7 and other adhesives.

Table 2 below gathers the results obtained with surface treatment solutions on the same metal sheets as those used for the tests reported in table 1. Thus, a solution of aminopropylsiloxane (γ-APS) and different solutions of glycidoxypropylsiloxane (γ-GPS) with pH levels adjusted in an acid range were applied by a spin coater and tested. The indicated hydrolysis time is that corresponding to the preparation of the surface treatment solution.

As can be seen from reading table 2, the use of acid surface treatment solutions makes it possible to improve the break facies.

TABLE 2

| | Concentration | | Hydrolysis | |
|---|---|---|---|---|
| Surface treatment solution | (wt %) | pH | time | Types of break |
| 3-aminopropyltrimethoxysilane | 0.1% | Not | 18 h | 100% AB |
| | | adjusted | | |
| | | (~10) | | |
| (3- | 0.1% | 3 | 18 h | 55% AB and |
| glycidoxypropyl)triethoxysilane | | | | 45% SCB |
| (3- | 0.1% | 3 | 1. | 50% AB and |
| glycidoxypropyl)triethoxysilane | | | | 50% SCB |
| (3- | 0.5% | 3 | 1 h | 50% AB and |
| glycidoxypropyl)triethoxysilane | | | | 50% SCB |
| (3- | 0.1% | 2 | 1 h | 40% AB and |
| glycidoxypropyl)triethoxysilane | | | | 60% SCB |

1-16. (canceled)

17. A method for producing a metal sheet, the method comprising at least the following steps:
providing a steel substrate having two faces each coated with a metal coating obtained by dipping the substrate in a bath and cooling, each metal coating comprising zinc, between 0.7 and 6 wt % of aluminum, and between 0.1 and 10 wt % of magnesium, then
applying an acid solution with a pH between 1 and 4 on outer surfaces of the metal coatings, then
applying an adhesive locally on at least one outer surface of a metal coating, the adhesive being at least one of structural, reinforced structural or semi-structural adhesives, sealing putties and wedging putties, then
assembling with a second metal sheet via the adhesive.

18. The method according to claim 17, wherein the metal coatings comprise between 0.3 and 10 wt % of magnesium.

19. The method according to claim 18, wherein the metal coatings comprise between 0.3 and 4 wt % of magnesium.

20. The method according to claim 17, wherein the metal coatings comprise between 1 and 6 wt % of aluminum.

21. The method according to claim 17, wherein a weight ratio between the magnesium and the aluminum in the metal coatings is less than or equal to 1.

22. The method according to claim 21, wherein the weight ratio between the magnesium and the aluminum in the metal coatings is less than 1.

23. The method according to claim 22, wherein the weight ratio between the magnesium and the aluminum in the metal coatings is less than 0.9.

24. The method according claim 17, wherein the acid solution is applied during a duration between 0.2 s and 30 s on the outer surfaces of the metal coatings.

25. The method according to claim 24, wherein the acid solution is applied during a duration between 0.2 s and 15 s on the outer surfaces of the metal coatings.

26. The method according to claim 25, wherein the acid solution is applied during a duration between 0.5 s and 15 s on the outer surfaces of the metal coatings.

27. The method according to claim 17, wherein the acid solution is a surface treatment solution for forming layers improving the corrosion resistance or adherence on the outer surfaces.

28. The method according to claim 17, the method further comprising, before the step for applying the adhesive, a surface treatment step by applying a surface treatment solution on the outer surfaces of the metal coatings to form layers improving the corrosion resistance or adherence.

29. The method according to claim 27, wherein the surface treatment solution is a conversion solution.

30. The method according to claim 17, the method further comprising, before the step for applying the adhesive, a degreasing step by applying an alkaline solution on the outer surfaces of the metal coatings.

31. The method according to claim 17, wherein the acid solution used has a pH between 1 and 3.5.

32. The method according to claim 31, wherein the acid solution has a pH between 1 and 3.

33. The method according to claim 32, wherein the acid solution has a pH between 1 and 2.

34. The method according to claim 17, wherein the acid solution comprises a silane.

35. The method according to claim 34, wherein the silane is chosen from 3-aminopropyltrimethoxysilane and (3-glycidoxypropyl)triethoxysilane.

36. A metal sheet assembled with a second metal sheet obtainable by the method according to claim 17.
